(19) United States
(12) Patent Application Publication
(10) Pub. No.: US 2026/0073278 A1
(43) Pub. Date: Mar. 12, 2026

(54) COMPUTER-IMPLEMENTED METHODS, SYSTEMS COMPRISING COMPUTER-READABLE MEDIA, AND ELECTRONIC DEVICES FOR GENERATIVE AI ASSISTED LABELING IN OPEN BANKING

(71) Applicant: Mastercard International Incorporated, Purchase, NY (US)

(72) Inventors: Sumedh Khandeparkar, Mumbai (IN); Brijesh Garabadu, Sandy, UT (US); Chandra Tupelly, Newark, CA (US); Cody Maughan, Bountiful, UT (US); Saurabh Singh, South Jordan, UT (US)

(73) Assignee: Mastercard International Incorporated, Purchase, NY (US)

(21) Appl. No.: 18/828,653

(22) Filed: Sep. 9, 2024

(51) Int. Cl. G06N 20/00; G06Q 40/02

(52) U.S. Cl. CPC G06N 20/00; G06Q 40/02

(57) ABSTRACT

A computer-implemented method for generative artificial intelligence (AI) assisted labeling of open banking (OB) data that includes: keyword based labeling to generate a keyword labeled subset and a first insufficiently labeled subset, respectively meeting or not meeting keyword based labeling criteria; diverting the keyword labeled subset from labeling by a large language model (LLM); submitting prompts for training labels to the LLM for the first insufficiently labeled subset to generate an LLM-labeled subset and a second insufficiently labeled subset, respectively meeting and not meeting LLM labeling criteria; diverting the LLM-labeled subset from labeling by human labelers; and submitting requests for training labels to the human labelers for the second insufficiently labeled subset to generate a human-labeled subset.

### FIELD OF THE INVENTION

The present disclosure generally relates to computer-implemented methods, systems comprising computer-readable media, and electronic devices for generative artificial intelligence (AI) assisted labeling and, more particularly, to an iterative three-stage labeling system for use with open banking (OB) data that incorporates interposed kick-out filters for evolved reduction in large language model (LLM) burden.

### BACKGROUND

Manual data labeling used in training machine learning models—e.g., via supervised training - requires huge expenditures of time. However, attempts to replace manual labeling have consistently resulted in sacrifices of accuracy and usefulness of the labeled data. Moreover, AI models supporting annotation and labeling efforts often carry high computational resource demands, in addition to accuracy problems, and therefore represent their own limitations.

Accordingly, significant and persistent involvement by human labelers is, under existing technology paradigms, indispensable for labeling OB data, at least because unique domain knowledge is required.

This background discussion is intended to provide information related to the present invention which is not necessarily prior art.

### BRIEF SUMMARY

Embodiments of the present technology relate to computer-implemented methods, systems comprising computer-readable media, and electronic devices for generative AI assisted labeling of OB data. The embodiments provide a technological mechanism for evolved reduction in LLM and manual labeling burdens in connection with OB data annotation. Namely, embodiments of the present invention include an iterative three-stage labeling system for use with OB data annotation that incorporates interposed kick-out filters enabling such evolved burden reductions.

More particularly, in an aspect, a computer-implemented method for generative AI assisted labeling of OB data may be provided. The method may include: keyword based labeling to generate a keyword labeled subset and a first insufficiently labeled subset, respectively meeting and not meeting keyword based labeling criteria; diverting the keyword labeled subset from labeling by a large language model (LLM); submitting prompts for training labels to the LLM for the first insufficiently labeled subset to generate an LLM-labeled subset and a second insufficiently labeled subset, respectively meeting and not meeting LLM labeling criteria; diverting the LLM-labeled subset from labeling by human labelers; and submitting requests for training labels to the human labelers for the second insufficiently labeled subset to generate a human-labeled subset. The method may include additional, less, or alternate actions, including those discussed elsewhere herein.

In another aspect, non-transitory computer-readable storage media having computer-executable instructions stored thereon for generative AI assisted labeling of OB data may be provided. When executed by at least one processor the computer-executable instructions cause the at least one processor to: perform keyword based labeling to generate a keyword labeled subset and a first insufficiently labeled subset, respectively meeting and not meeting keyword based labeling criteria; divert the keyword labeled subset from labeling by a large language model (LLM); submit prompts for training labels to the LLM for the first insufficiently labeled subset to generate an LLM-labeled subset and a second insufficiently labeled subset, respectively meeting and not meeting LLM labeling criteria; divert the LLM-labeled subset from labeling by human labelers; and submit requests for training labels to the human labelers for the second insufficiently labeled subset to generate a human-labeled subset. The instructions, when executed, may cause the at least one processor to perform additional, less, or alternate actions, including those discussed elsewhere herein.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

FIG. 1 illustrates various components, in block schematic form, of an exemplary system for generative AI assisted labeling of OB data in accordance with embodiments of the present invention;

FIGS. 2, 3 and 4 illustrate various components of exemplary computing devices shown in block schematic form that may be used with the system of FIG. 1;

FIG. 5 is a flowchart of exemplary systems and components thereof for generative AI assisted labeling of OB data, in accordance with embodiments of the present invention; and

FIG. 6 illustrates at least a portion of the steps of an exemplary computer-implemented method for generative AI assisted labeling of OB data in accordance with embodiments of the present invention.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Existing methods for labeling OB data for training of machine learning models are heavily manual or, where AI tools are used for annotation, sacrifice accuracy and/or carry high computational resource burdens.

According to embodiments of the present invention, a technological mechanism is provided for generative AI assisted labeling of OB data. The embodiments enable an evolved reduction in LLM and manual labeling burdens in connection with OB data annotation and labeling. Namely, embodiments of the present invention include an iterative three-stage labeling system for use with OB data annotation that incorporates interposed kick-out filters enabling such evolved burden reductions.

### Exemplary System

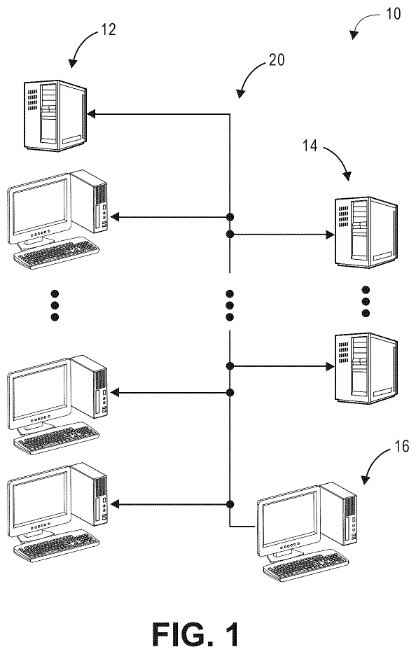

FIG. 1 depicts an exemplary environment 10 for generative AI assisted labeling of OB data, according to embodiments of the present invention. The environment 10 may include a plurality of human labeler devices 12, a plurality of servers 14, a service device 16, and a communication network 20. Human labeler devices 12, servers 14 and the service device 16 may be located within network boundaries of an organization, such as a corporation or the like that provides open banking services. One or more human labeler devices 12 and servers 14 may also be outside the network boundaries of the organization.

The communication network 20 may be partly or even mostly internal to the organization, for example where the servers 14 manage databases of and/or provide cloud-based services to and under the management of the organization, and a human labeler device 12 is also under the management of the organization. Also or alternatively, the human labeler devices 12, servers 14 and service device 16 may access each other via transmissions, at least in part, across public/semi-public telecommunication network infrastructure, with the communication network 20 being at least in part comprised of such public/semi-public telecommunication network infrastructure.

All or some of the human labeler devices 12, servers 14, service device 16 and/or all or some of the virtual resources managed thereby, may at least partly comprise a secure network computing environment. Alternatively or in addition, the service device 16 may manage access and transmissions between and among itself and the human labeler devices 12 and servers 14 under an authentication management framework. For example, each user of a human labeler device 12 may be required to complete an authentication process to access secure data provided via the servers 14 and/or the services provided by and/or to service device 16. In one or more embodiments, any authentication management framework may be utilized including, without limitation, custom frameworks.

For example, the service device 16 may host, aggregate and analyze data and host and provide access to/use of applications comprising open banking services. In one or more embodiments, the open banking services comprise data aggregation, analysis, management and data sharing services whereby consumers and businesses may subscribe for consented and controlled sharing of data with financial service providers and/or institutions.

The service device 16 also or alternatively manages open banking data annotation and/or labeling operations, enabling supervised training of OB machine learning models for use by the organization, according to embodiments of the present invention.

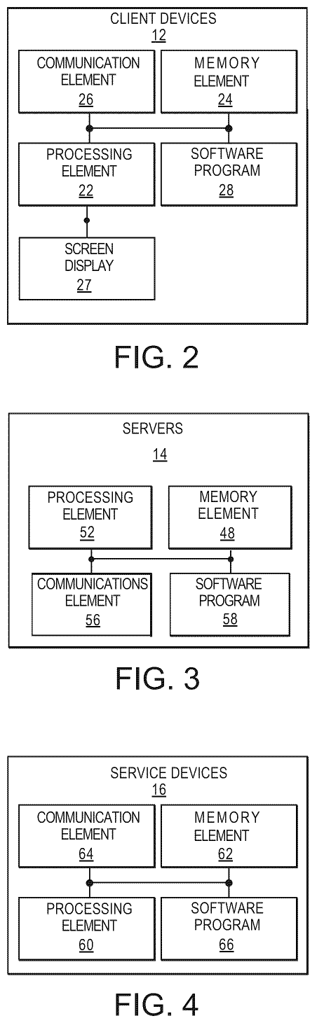

Turning to FIGS. 2 and 4, generally the human labeler devices 12 and the service device 16 may include tablet computers, laptop computers, desktop computers, workstation computers, smart phones, smart watches, and the like. In one or more embodiments, the human labeler devices 12 and/or the service device 16 may comprise server(s), examples of which are discussed in more detail below.

Human labeler devices 12 and service device(s) 16 may each respectively include a processing element 22, 60, a memory element 24, 62, and circuitry capable of wired and/or wireless communication with the communication network 20, including, for example, a transceiver or communication element 26, 64. Each of the human labeler devices 12 may additionally include a screen display 27, which may comprise a user interface of the human labeler device 12. The display 27 may include video devices of any of the following types: plasma, standard or ultra-high-definition light-emitting diode (LED), organic LED (OLED), quantum dot LED (QLED), Light Emitting Polymer (LEP) or Polymer LED (PLED), liquid crystal display (LCD), thin film transistor (TFT) LCD, LED side-lit or back-lit LCD, or the like, or combinations thereof. The display 27 may possess a square or a rectangular aspect ratio and may be viewed in either a landscape or a portrait mode. In various embodiments, the display 27 may also include a touch screen occupying all or part of the screen.

Further, each of the human labeler devices 12 and the service device 16 may include a software application or program 28, 66 configured with instructions for performing and/or enabling performance of at least some of the steps set forth herein. In an embodiment, the software programs 28, 66 each comprises instructions respectively stored on computer-readable media of a memory element 24, 62.

The servers 14 generally receive requests for open banking data sharing directly or indirectly from the service device 16, optionally manage a consent process for obtaining consent for such sharing from data subjects, and expose or otherwise provide such open banking data to the service device 16 for training and data labeling/annotation operations. In one or more embodiments, the service device 16 enrolls all or some of the human labeler devices 12 and servers 14 and/or the resources embodied thereby for participation in the training and data labeling/annotation operations. Further, in one or more embodiments, the servers 14 host large language model(s) (LLMs) described herein.

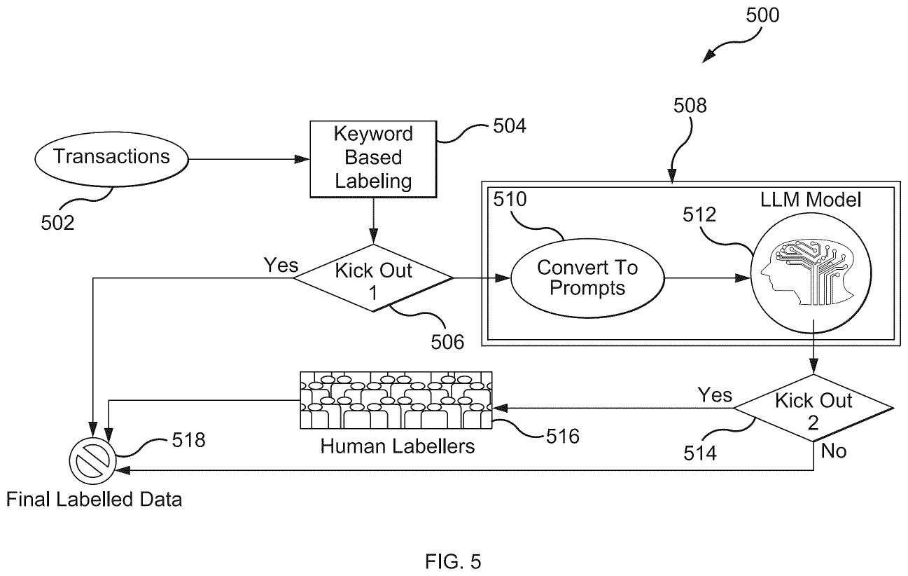

The servers 14 may comprise cloud servers, domain controllers, application servers, database servers, database web servers, file servers, mail servers, catalog servers or the like, or combinations thereof. In one or more embodiments, one or more data sources (see Transactions 502 of FIG. 5) may be maintained by one or more of the servers 14. Generally, each server 14 may include a memory element 48, a processing element 52, a communication element 56, and a software program 58.

The communication network 20 generally allows communication between the human labeler devices 12, the servers 14, and the service device 16, for example in conjunction with device enrollment, data acquisition, data consenting, data labeling, data filtering and label sufficiency evaluations, LLM fine-tuning, and keyword based labeling rule revision operations managed by the service device 16.

The communication network 20 may include the Internet, cellular communication networks, local area networks, metro area networks, wide area networks, cloud networks, plain old telephone service (POTS) networks, and the like, or combinations thereof. The communication network 20 may be wired, wireless, or combinations thereof and may include components such as modems, gateways, switches, routers, hubs, access points, repeaters, towers, and the like. The human labeler devices 12, servers 14 and/or services device(s) 16 may, for example, connect to the communication network 20 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The communication elements 26, 56, 64 generally allow communication between the human labeler devices 12, the servers 14, the service device 16 and/or the communication network 20. The communication elements 26, 56, 64 may include signal or data transmitting and receiving circuits, such as antennas, amplifiers, filters, mixers, oscillators, digital signal processors (DSPs), and the like. The communication elements 26, 56, 64 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard such as WiFi, IEEE 802.16 standard such as WiMAX, Bluetooth™, or combinations thereof. In addition, the communication elements 26, 56, 64 may utilize communication standards such as ANT, ANT+, Bluetooth™ low energy (BLE), the industrial, scientific, and medical (ISM) band at 2.4 gigahertz (GHz), or the like. Alternatively, or in addition, the communication elements 26, 56, 64 may establish communication through connectors or couplers that receive metal conductor wires or cables, like Cat 6 or coax cable, which are compatible with networking technologies such as ethernet. In certain embodiments, the communication elements 26, 56, 64 may also couple with optical fiber cables. The communication elements 26, 56, 64 may respectively be in communication with the processing elements 22, 52, 60 and/or the memory elements 24, 48, 62.

The memory elements 24, 48, 62 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory elements 24, 48, 62 may be embedded in, or packaged in the same package as, the processing elements 22, 52, 60. The memory elements 24, 48, 62 may include, or may constitute, a “computer-readable medium.” The memory elements 24, 48, 62 may store the instructions, code, code segments, software, firmware, programs, applications, apps, services, daemons, or the like that are executed by the processing elements 22, 52, 60. In an embodiment, the memory elements 24, 48, 62 respectively store the software applications/programs 28, 58, 66. The memory elements 24, 48, 62 may also store settings, data, documents, sound files, photographs, movies, images, databases, and the like.

The processing elements 22, 52, 60 may include electronic hardware components such as processors. The processing elements 22, 52, 60 may include digital processing unit(s). The processing elements 22, 52, 60 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing elements 22, 52, 60 may generally execute, process, or run instructions, code, code segments, software, firmware, programs, applications, apps, processes, services, daemons, or the like. For instance, the processing elements 22, 52, 60 may respectively execute the software applications/programs 28, 58, 66. The processing elements 22, 52, 60 may also include hardware components such as finite-state machines, sequential and combinational logic, and other electronic circuits that can perform the functions necessary for the operation of embodiments of the current invention. The processing elements 22, 52, 60 may be in communication with the other electronic components through serial or parallel links that include universal busses, address busses, data busses, control lines, and the like.

Data sources hosted by the servers 14 may utilize a variety of formats and structures within the scope of the invention. For instance, relational databases and/or object-oriented databases may embody the data sources, and may be exposed for queries by one or more corresponding APIs. One of ordinary skill will appreciate that—while examples presented herein may discuss specific types of operating systems and/or databases—a wide variety may be used alone or in combination within the scope of the present invention.

The program 58 may be configured with policies that define limits to data access, for example with respect to data volume and/or frequency/timing of access events, by the service device 16. In one or more embodiments, these may include financial institution (FI) rate limits. In one or more embodiments, the service device 16 negotiates such limits (e.g., imposed by financial FIs operating the server(s) 14) by prioritizing data access and aggregation for training and labeling operations which require more frequent access, are associated with OB machine learning models which are in more demand, or otherwise to optimize and balance business objectives of the open banking service provider.

In one or more embodiments, training and labeling operations include the service device 16 implementing a three-stage labeling system for use with OB data that incorporates interposed kick-out filters for evolved reduction in LLM and human-labeler burden without sacrificing accuracy. OB data labeled by such a system may be more readily, quickly, and accurately produced, thereby enabling quicker and more nimble training of OB machine learning models. In one or more embodiments, this enables the OB service provider to adapt to changing conditions and/or expand into additional geographic markets with relative ease.

The training and labeling operations of embodiments of the present invention, and the corresponding OB machine learning models whose training is enabled by such training data, may generally seek to improve machine identification of datums within unstructured data. The identification may include mapping the datums to known categories, entities or the like. For example, the datums may appear in various representations (e.g., in abbreviations, conjugations, or other varieties), and may be mappable to a variety of known categories, entities or the like, such as where several known categories or entities have known representations comprising similar strings. In one or more embodiments, the training and labeling operations and corresponding OB machine learning models seek to improve accuracy and computational efficiency of developing rules for mapping datums or strings in unstructured data to labels and/or known entities, known categories, or the like.

For example, the training and labeling operations and corresponding OB machine learning models may seek to identify transactional entities in unstructured data (e.g., in memo and description fields in open banking transaction data) and to associate or map representations and descriptions of those entities to corresponding training labels and/or a standardized identity. They may also/alternatively seek to identify geographic location(s) for entities, categorize entities into product/service/industry types, categorize or generate explanations for financial transactions (e.g., purposes of or reasons for the transactions, identify transaction type(s), or the like). One of ordinary skill will appreciated, however, that a variety of OB training and labeling tasks are within the scope of the present invention.

In one or more embodiments, the program 66 is configured to perform the three-stage filtered labeling and annotation operations. Further, the program 66 is configured to iterate through labeling cycles to dynamically improve accuracy of low computational burden resources of one or more stages of the system, and thereby relieve high computational burden resources in later iterations.

The example system of FIG. 5 includes: transactions or OB transaction data 502; keyword based labeling process 504; first kickout filter 506; LLM 508, including prompt conversion process 510 and LLM model 512; second kickout filter 514; human labelers 516; and final labeled data 518.

The OB transaction data 502 may comprise a plurality of transaction records such as records of financial transactions that include related transaction data such as one or more of date, amount, transacting entity(ies), merchant category or product(s)/service(s), or the like. The data may be in the form of alphanumeric and character/symbol strings. The transactions 502 may be provided by one or more servers 14 which may, in turn, be associated with a financial service provider, financial institution, an acquirer service, a credit card payment network, a database storing data originating with one or more of the foregoing, or otherwise within the scope of the present invention. The records of the transactions 502 may be in completely or partially unstructured and/or unlabeled format, and may comprise memo and description fields of OB transaction records.

The keyword based labeling process 504 may comprise a component, module and/or process of a program (e.g., program 66) executed by the service device 16. The keyword based labeling process 504 may tokenize the strings of the transaction records 502. The method of tokenization may vary depending on the keyword based labeling algorithm used.

For example, the tokens derived from each record of the plurality of records of the transactions 502 may be compared against a plurality of rules. Exemplary embodiments of the rules of the data labeling software algorithm or program may be written in JavaScript object notation (json). The plurality of rules may define respective string matching or token matching criteria or conditions. Each of the plurality of rules may including parsing and analysis techniques such as n-gram analysis, regular expression (regex) analysis, fuzzy matching, lookup tables and the like. N-gram analysis typically involves sequentially grouping the text of the record into n-word clusters, where n is an integer value. As an example, if n=2, then the first word and the second word would be grouped, the third word and the fourth word would be grouped, and so forth. Regex analysis typically involves searching the text of the record for a string of characters, wherein the characters may vary. Fuzzy matching typically involves searching for variations of a particular term, wherein the variations may include different spellings of a word, the inclusion of spaces or dashes, and the like.

One of ordinary skill will appreciate that a variety of known keyword based labeling algorithms may be used in accordance with embodiments of the present invention.

In one or more embodiments, each rule associates one of a plurality of labels with one or more portions of the OB transaction record according to one or more keywords of the record. Each rule looks for one or more of the keywords and then associates a label with the record which varies according to the keywords. For example, a first rule may search the record for a first keyword (e.g., in token form) and associate a first label with the record if the first keyword (or a sufficiently similar variation thereof) is found. A second rule may search the record for a second keyword (or a sufficiently similar variation thereof) and associate a second label with the record if the second keyword is found, and so forth with successive rules, keywords, and labels.

In some instances, a plurality of rules may search each record for variations of spellings of a particular keyword and associate a label accordingly. For example, a first rule may search the record for a first variation of a keyword, a second rule may search for a second variation of the keyword, and so forth. Each rule may associate the same label with the record if any of the variations of the keyword are found.

In some instances, a portion (e.g., string(s)) of a record may match to two or more of the plurality of rules and/or keyword(s). The rules may be ranked by priority, and the rule with highest priority may be selected in such instances. The priority may be a numerical value that may be specified or assigned by human programmers, software algorithms, or artificial intelligence. In one or more embodiments, rules with a higher priority are applied before those with a lower priority, wherever there are conflicts and/or overlapping identifications. A prioritization algorithm or other portion of the service device program may automatically maintain priorities for the plurality of rules, and can include hardcoded prioritization, super-rule/sub-rule prioritization, and/or accuracy-based prioritization components.

It should also be noted that each rule may include additional conditions. The additional conditions may include Boolean (true/false) statements and may check relational conditions such as greater than, equal to, etc., which can be used to determine the sign (positive or negative) and range of values of numbers. Other additional conditions may check for secondary keywords. All of the additional conditions for a given rule must be met, i.e., the Boolean statements must be true, before the rule is applied.

In an example, a first rule, with a highest priority, may search a record for a first one or more keywords and associate a first label with the record if the first one or more keywords is found and a first set of conditions is met. A second rule, with a second highest priority, may search the record for the first one or more keywords and associate a second label with the record if the first keyword is found and a second set of conditions is met. Specifically, in one instance, a plurality of rules may search a particular record for the keyword or string “payment.” A first rule may associate the label “mortgage” with the record if the keyword “payment” is included and a first set of conditions is met. A second rule may associate the label “loan payments” with the record if the keyword “payment” is included and a second set of conditions is met. A third rule may associate the label “credit card payments” with the record if the keyword “payment” is included and a third set of conditions is met. A fourth rule may associate the label “income” with the record if the keyword “payment” is included and a fourth set of conditions is met. The process may continue with successive rules, labels, conditions, and the same one or more keywords.

Further, each of the plurality of rules may be associated with a confidence indicator, reflecting how confident the system is in the label applied by each rule to the corresponding portion of the transaction record. For example, longer strings, more frequently encountered strings, strings that are not proximate in terms of distance to other strings mapped to other entity or category labels, or the like may be associated with high confidence. The confidence indicators may be logical (e.g., “high,” “medium” or “low”), numerical (e.g., on a scale of 1-10) or otherwise within the scope of the present invention. Each string may be associated with its own confidence indicator within the plurality of rules.

In one or more embodiments, the confidence indicator may by synonymous with, or may drive at least in part, the corresponding priority of a rule. For example, in one or more embodiments, the confidence indicator for a rule is the priority value, at least in part because the system may regard confidence in label application (i.e., accuracy) to be of highest priority.

However, it is also foreseen that the confidence indicator may not be synonymous with, though still related to, priority. For example, a first rule may specify a first, more general label, which may be applied with 100% confidence to a string or portion of a record. A second rule may specify a second, more specific label, which may be applied with 98% confidence to the same or a coincident string or portion of the record. Prioritization of the rules may indicate that the 98% confidence in the second rule is sufficient to justify its application, e.g., because the specificity offered by the corresponding second label is highly preferred for use in training OB machine learning models.

It should also be noted that, in one or more advantageous embodiments, the plurality of rules may be automatically revised. For example, in one or more embodiments, the program 66 of the service device 16 may be configured to automatically identify labeling occurrences—e.g., of LLM model 512 and/or human labelers 516—along with the corresponding string(s) and labels, and to automatically generate and/or revise corresponding rules of the keyword based labeling component 504 based thereon. The service device 16 may be configured to automatically adjust the definitions, criteria and/or conditions embodied in one or more of the plurality of rules and/or to adjust corresponding prioritization and/or confidence indicators, as discussed in more detail below.

The keyword based labeling process 504 may accordingly apply labels to portions of records of the transactions 502 using the plurality of rules, with such rules being automatically adjustable.

The records of the transactions 502 output by the keyword based labeling process 504 are submitted to first kickout filter 506. The filter 506 determines which of the records are sufficiently annotated or labeled for inclusion in training data for the OB machine learning model(s). In one or more embodiments, the determination is made based on one or more pre-determined thresholds or criteria for such training data. The criteria or thresholds applied by the filter 506 may be generated and/or retrieved based on the training and/or OB machine learning model in question.

For example, the program 66 may be configured to retrieve or generate the thresholds or criteria based on a predefined training task the training data is to be used for. In one or more embodiments, the program 66 will be tasked with generating training data to improve one of the OB machine learning models' ability to map informal entity monikers within unstructured data to standardized entity names (i.e., named entity recognition), with an emphasis on accuracy over specificity. Accordingly, the program 66 may generate and/or retrieve criteria or thresholds reflecting these training goals, and apply same to the records output from the keyword based labeling process 504.

The criteria may, for example, require that certain label types be applied or present in a record, with or without attached requirements for priority and/or confidence indicator(s) from the rules which applied the label(s). One of ordinary skill will appreciate that other criteria may also be included, for example where rules of the criteria specify that one or more combinations of label types and/or co-dependent confidence and/or prioritization are required.

For example, a record score may be generated for each of the records output by the keyword based labeling process 504. The record score may be a summation or other calculated figure, and may take into account each applied label and each corresponding confidence indicator, as well as other logical conditions. In one or more embodiments, high confidence indicators for labels, and relatively few or no missing labels, lead to a high or favorable record score. It is also foreseen that the various label categories for a given record may be weighted in such a score, such that missing or low confidence labels for a first label type may reduce the corresponding record score relatively little, whereas such a deficiency for a label of another type may significantly reduce the score. Conversely, low confidence indicators and/or more missing labels may lead to a lower or less favorable record score. Lower or less favorable record scores are more likely to cause a record to be deemed insufficiently labeled according to the criteria.

Each record which meets the criteria of the filter 506 may be flagged or otherwise considered sufficiently labeled and ready for use in training data for the OB machine learning models. For example, in one or more embodiments, each such record or group of such records may be stored in a memory space from which training data are retrieved or derived, flagged with a value indicating sufficient labeling, or otherwise segregated and/or indicated.

Those records which do not meet the criteria of the filter 506 may be subjected to further labeling processes. In one or more embodiments, the program 66 submits same for labeling by the LLM 508.

In one or more embodiments, the LLM 508 is hosted by or accessible to a service device 16 for implementation in training and labeling operations. However, in one or more embodiments, the LLM 508 and its components may also or alternatively be hosted outside of the service provider organization and/or service device 16, for example where the LLM 508 and/or LLM model 512 is hosted in a cloud computing environment (e.g., on server(s) constructed in accordance with servers 14 discussed herein). In one or more embodiments, the LLM 508 is hosted in a private cloud environment and/or is hosted remotely and accessible via application programming interface (API) call. One of ordinary skill will appreciate that responsibility for all or some of such components may be distributed differently among such devices or other computing devices without departing from the spirit of the present invention.

In one or more embodiments, the LLM 508 is initially a licensed model such as those made available under the trademarks GPT-4® or CHATGPT® (registered trademarks of OpenAI OpCo, LLC), MISTRAL 7B™ (trademark of Mistral AI, a French simplified joint-stock company), or OPEN-LLAMA™ (trademark of Hugging Face, Inc.), as of the date of the initial filing of the present disclosure.

As discussed above, the LLM 508 may be hosted in a cloud computing environment, locally on one or more service devices 16, or otherwise within the scope of the present invention. The generalized training or pretraining of the LLM 508—in the state received under a license, for example—may be conducted on a wide variety of data, according to known practices associated with commercially available models such as those listed above.

A preliminary step according to embodiments of the present invention may include selecting an LLM 508 trained on language expected to be predominantly encountered in prompts and fine-tuning data corresponding to OB service machine learning tasks and/or the OB service and/or region in which the OB service will predominantly be provided. For example, the LLM 508 may be trained on English, French, Spanish, German, Mandarin, Cantonese, Arabic, Hindi or other languages, and may be more particularly trained on data filtered for region or ethnicity (e.g., American English or British English), financial channel and/or other differences. Because the LLM 508 will mostly encounter and output language unique to conversations reliant on particularized OB data and vernacular, it is also foreseen that additional filters—such as for language used in economic, financial and transactional contexts—may additionally be applied to select LLMs 508 trained on particularly relevant language within the scope of the present invention.

Further, fine-tuning of the LLM 508 may be initially performed (e.g., before being used for OB data labeling operations) in view of the labeling tasks for which it is to be used. In one or more embodiments, fine-tuning includes one or more of self-supervised, supervised and/or reinforcement learning. The fine-tuning may be performed with data types including open banking data such as memo or description fields of open banking records, FI data, transaction and credit card data, account data, firmographic entity data, location data, entity identification and/or authentication data, and/or other financial and relevant data, and combinations thereof.

Similarly, the initially fine-tuned LLM may be tested with one or more prompts, preferably engineered according to one or more predefined strategies, to determine capabilities, efficiency and accuracy with reference to OB data labeling and training tasks. Where OB data is submitted with the test prompts, it likewise may originate with or include memo or description fields of open banking records, FI data, transaction and credit card data, account data, firmographic entity data, location data, entity identification and/or authentication data, and/or other financial and relevant data, and combinations thereof.

As discussed in more detail below, iterative fine-tuning or training steps are also or alternatively undertaken in or following use in a production data labeling environment, based on patterns and correlations and other data gathered from or recognized in human labeled records.

The program 66 submits records which do not meet the criteria of the filter 506 (insufficiently labeled records) for labeling by the LLM model.

In one or more embodiments, control components (not shown) of the program 66 search the data intended to be input to or output from the LLM 508—whether as query embeddings, training embeddings, or answer/output embeddings, or unencoded upstream/downstream textual versions thereof—to identify personally identifiable information (PII) and other sensitive or confidential information. For example, the control components may use lookup tables, pattern matching or other technologies to locate and identify PII and sensitive and/or confidential information, and redact, anonymize and/or replace same (e.g., with nonce symbols, pseudonyms, or keys or tokens).

The records or portions thereof which are submitted to the LLM 508 as prompts 510 are encoded and tokenized versions of the original textual information included in the records of transactions 502. Likewise, output or answers of the LLM 508 are decoded from tokenized versions to human readable text. Encoding/decoding and tokenization enabling translation of human to machine language interpretable by the LLM 508 may be performed generally in accordance with known LLM practices.

The prompts 510 may include open banking data for single- or multi-shot prompting. The prompt 510 may be configured and engineered to optimize the quality of the output. For example, the prompt may include a significant number of relevant examples relevant to the query it embodies (e.g., for single shot or multi-shot learning), and may include a plurality of financial account records or portions thereof, in each case to provide context to activate the LLM model 512 toward the most likely relevant learned relationships it embodies. It is also foreseen that the data prompts 510 are optimized according to the formats, syntaxes and contents encountered within the OB data and query type within which the LLM model 512 is configured to perform labeling operations.

The LLM model 512 may process each prompt 510 and generate an output, which may be evaluated by a second kickout filter 514 of the program 66. More particularly, the LLM model 512 may respond to prompts to label the transaction records 502 which were insufficiently labeled by keyword based labeling 504. The output may include one or more of the requested label(s), the corresponding portions of string(s) of the prompt and/or transaction record 502 mapped to the requested label(s), a confidence indicator for the labeling, an explanation of the weightings and/or reasons why the label(s) were applied, and/or other relevant datums.

The second filter 514 determines which of the records output from the LLM model 512 are sufficiently annotated or labeled for inclusion in training data for the OB machine learning models. In one or more embodiments, the determination is made based on one or more pre-determined thresholds or criteria for such training data. The criteria or thresholds applied by the filter 514 may be generated and/or retrieved based on the training and/or OB machine learning model in question.

For example, the program 66 may be configured to retrieve or generate the thresholds or criteria for the filter 514 based on a predefined training task the training data is to be used for. In one or more embodiments, the program 66 will be tasked with generating training data to improve one of the OB machine learning models'ability to map informal entity monikers within unstructured data to standardized entity names (i.e., named entity recognition), with an emphasis on accuracy over specificity. Accordingly, the program 66 may generate and/or retrieve criteria or thresholds reflecting these training goals, and apply same to the records output from the LLM model 512. The criteria may, for example, require that certain label types be applied or present in a record, with or without attached requirements for confidence indicator(s) associated by the LLM model 512 with the label(s). One of ordinary skill will appreciate that other criteria may also be included, for example where one or more rules of the criteria specify that one or more combinations of label types and/or co-dependent confidence indicator(s) are required.

Further, in one or more embodiments, the criteria applied by filter 514 may be specially configured for interpreting LLM outputs. More particularly, the filter 514 may perform a training label hallucination cross-check between the string(s) of the records input to the LLM on the one hand (i.e., records which did not meet the criteria of the filter 506), and the string(s) identified with labels in the LLM output on the other hand. If the LLM 508 based its labeling on string(s) which do not have sufficiently similar predicates in the input records, or otherwise hallucinated or introduced new information not derived or derivable from the input records, the program 66 may reject the labels and/or annotations of the LLM model 512 and/or mark same as insufficiently labeled. In one or more embodiments, the tokens of input OB transaction records 502 are compared with the labels output by the LLM model 512—whether in textual or encoded/tokenized format, and possibly in json raw format—to find exact as well as fuzzy match(es).

The filter 514 may also or alternatively perform a training label category check for each record output by the LLM model 512. Because LLMs may be prompted for a limited number of acceptable labels applied to portions of input records, but are configured more broadly on all types of language and sources of data, it is foreseen that the LLM model 512 may return responses to the prompts that include labels which themselves are unresponsive and/or are not recognizable labels for inclusion with the training data. For example, the prompt associated with a record may ask the LLM model 512 to identify and label the record with a “merchant entity location,” and the LLM model 512 may respond with the label “headquarters.” Because the prompt sought a geographic location label, but received an illegitimate type of “location” data label in output, the filter 514 may determine a label category error.

One of ordinary skill will appreciate that additional filtering, quality checking, and/or postprocessing may be performed on output from the LLM model 512 in embodiments of the present invention. For example, in one or more embodiments, additional fixed rules are added in a checking function to determine if labels output from the LLM model 512 satisfy other requirements, e.g., by checking for suffixes (e.g., “ltd,” “inc” or the like), adherence to known entity abbreviation(s), or the like.

Each record which meets the criteria of the filter 514 may be flagged or otherwise considered sufficiently labeled and ready for use in training data for the OB machine learning models. For example, in one or more embodiments, each such record or group of such records may be stored in a memory space from which training data are retrieved or derived, flagged with a value indicating sufficient labeling, or otherwise segregated and/or indicated.

Moreover, as discussed in more detail above, the program 66 may also be configured to automatically analyze sufficiently labeled LLM output records and revise or update the keyword based labeling process 504 accordingly. For example, string/label pairs which are more frequently output and/or have high and/or consistent confidence indicators, and/or the like, may lead the program 66 to create new rules for such mapping relationships and/or to revise associated priorities and/or confidence indicators within the plurality of rules of the keyword based labeling process 504.

Those records which do not meet the criteria of the filter 514 may be subjected to further labeling processes. In one or more embodiments, the program 66 submits same for labeling by human labelers 516.

The insufficiently labeled records 502 output by the LLM model 512 may be submitted with labeling requests to the human labelers 516 at devices 12. The human labelers 516 may analyze the records 502—e.g., by viewing representations of same at displays 27—and submit inputs to the devices 12 comprising labels, portions or strings of the records 502 corresponding to the labels, confidence indicator(s) for the labels, or the like.

Moreover, as discussed in more detail above, the program 66 may also be configured to automatically analyze sufficiently labeled human labeler 516 output records and revise or update the keyword based labeling process 504 accordingly. For example, string/label pairs which are more frequently output and/or have high and/or consistent confidence indicators, and/or the like, may lead the program 66 to create new rules for such mapping relationships and/or to revise associated priorities and/or confidence indicators within the plurality of rules of the keyword based labeling process 504.

Further, the program 66 may also be configured to automatically analyze sufficiently labeled human labeler 516 output records, generate corresponding fine-tuning training data for the LLM model 512, and fine-tune the LLM model 512 accordingly. For example, where a plurality of different and frequently output labels are associated with a variety of similar input string(s), making distinction between them and proper label application more difficult, the program 66 may be configured to automatically curate a labeled training data set with numerous examples embodying the various correct input string/label pairings and permutations thereof, and to fine-tune the LLM model 512 using the curated labeled training data set. Such fine-tuning may be conducted periodically (e.g., on a schedule determined by the program 66 based, for example, on monitoring LLM model 512 labelled transactions).

It is foreseen that machine learning methods may be used to support learning by the program 66 and/or service device 16 in connection with revising and/or updating the plurality of rules of the keyword based labeling process 504, updating filter criteria, and/or curating training data for and conducting fine tuning of the LLM model 512. The machine learning program(s) supporting the labeling system may therefore recognize or determine correlations between training labels and input record(s)/string(s) and associated datapoints.

The machine learning techniques or programs may include curve fitting, regression model builders, convolutional or deep learning neural networks, combined deep learning, pattern recognition, or the like. Based upon this data analysis, the machine learning program(s) may learn method(s) for revising and/or updating the plurality of rules of the keyword based labeling process 504, updating filter criteria, and/or curating training data for and conducting fine tuning of the LLM model 512, for use in improving embodiments of the present labeling system.

It should be noted that, in supervised machine learning, the labeling system may be provided with example inputs (i.e., input record strings) and their associated outputs (i.e., labels), and may seek to discover a general rule that maps inputs to outputs for improved revising and/or updating the plurality of rules of the keyword based labeling process 504, updating filter criteria, and/or curating training data for and conducting fine tuning of the LLM model 512. In unsupervised machine learning, the labeling system may be required to find its own structure in unlabeled example inputs.

The labeling system may utilize classification algorithms such as Bayesian classifiers and decision trees, sets of pre-determined rules, and/or other algorithms.

Through hardware, software, firmware, or various combinations thereof, the processing elements 22, 52, 60 may—alone or in combination with other processing elements—be configured to perform the operations of embodiments of the present invention. Specific embodiments of the technology will now be described in connection with the attached drawing figures. The embodiments are intended to describe aspects of the invention in sufficient detail to enable those skilled in the art to practice the invention. Other embodiments can be utilized and changes can be made without departing from the scope of the present invention. The system may include additional, less, or alternate functionality and/or device(s), including those discussed elsewhere herein. The following detailed description is, therefore, not to be taken in a limiting sense. The scope of the present invention is defined only by the appended claims, along with the full scope of equivalents to which such claims are entitled, unless otherwise expressly stated and/or readily apparent to those skilled in the art from the description.

### Exemplary Computer-Implemented Method for Generative AI Assisted Labeling of Open Banking Data

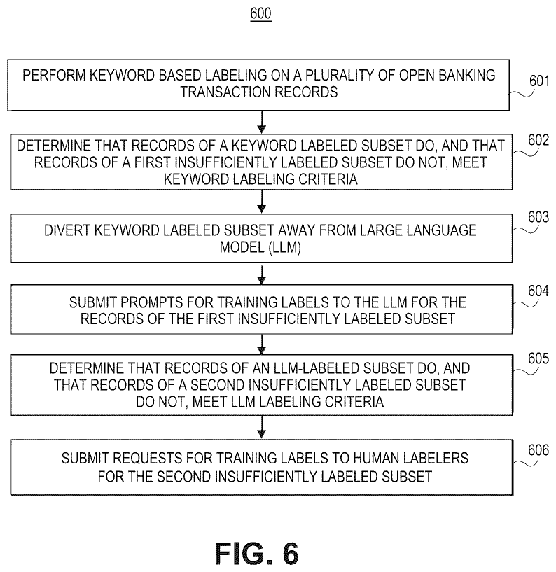

FIG. 6 depicts a flowchart including a listing of steps of an exemplary computer-implemented method 600 for providing AI assisted labeling of OB data. The steps may be performed in the order shown in FIG. 6, or they may be performed in a different order. Furthermore, some steps may be performed concurrently as opposed to sequentially. In addition, some steps may be optional.

The computer-implemented method 600 is described below, for ease of reference, as being executed by exemplary devices and components introduced with the embodiments illustrated in FIGS. 1-5. For example, the steps of the computer-implemented method 600 may be performed by the human labeler devices 12, the servers 14, the service device 16 and the network 20 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 601, keyword based labeling may be performed on a plurality of open banking transaction records. In one or more embodiments, the keyword based labeling process comprises or is executed by a program of a service device (e.g., process 504 of FIG. 5 executed on service device 16 of FIG. 1 in a local environment), as discussed in more detail in preceding sections and/or otherwise in accordance with the discussion above. Accordingly, it should be appreciated that related operations described above may also occur within the scope of the present invention.

Referring to step 602, it may be determined that records of a keyword labeled subset do, and that records of a first insufficiently labeled subset do not, meet keyword based labeling criteria. The keyword labeled subset and the first insufficiently labeled subset may each comprise records output from the keyword based labeling process.

In one or more embodiments, the determination is made by a kickout filter comprising or that is executed by a program of a service device (e.g., filter 506 of FIG. 5 executed on service device 16 of FIG. 1 in a local environment), as discussed in more detail in preceding sections, and/or otherwise in accordance with the discussion above. Accordingly, it should be appreciated that related operations described above may also occur within the scope of the present invention.

Referring to step 603, the records of the keyword labeled subset may be diverted away from a large language model (LLM). In one or more embodiments, the records are withheld - temporarily or on a longer-term basis - from being submitted for further labeling efforts by the LLM by a program of a service device (e.g., program 66 of service device 16 of FIG. 1, executed in a local environment), as discussed in more detail in preceding sections, and/or otherwise in accordance with the discussion above. Accordingly, it should be appreciated that related operations described above may also occur within the scope of the present invention.

Referring to step 604, prompts for training labels may be submitted to the LLM for the records of the first insufficiently labeled subset. In one or more embodiments, the LLM corresponds to an LLM model 512 (FIG. 5) which may be hosted in a local environment (e.g., on a service device 16) and/or in a remote environment (e.g., cloud computing and/or on servers 14), and prompts are prepared at 510 (FIG. 5). Accordingly, it should be appreciated that related operations describe above—such as PII filtering/redaction and/or encoding/decoding and tokenization translation processes—may also occur within the scope of the present invention.

In one or more embodiments, the LLM is preliminarily fine-tuned for OB financial data labeling tasks. For example, the LLM may be fine-tuned to label any one or more of the following: a financial transaction type, a financial transaction entity, a financial transaction location, a financial transaction entity category, and/or to apply other such labels. As noted in preceding sections, preliminary fine-tuning may also/alternatively acclimate the LLM to one or more languages encountered in the prompt(s), and/or to unique data formats, syntaxes and contents encountered within the open banking conversation for which it is configured.

The prompt may be configured and engineered to optimize the quality of the output. For example, the prompt may include a significant number of relevant examples relevant to the query it embodies (e.g., for single shot or multi-shot learning), and may include a plurality of financial account records or other data types, in each case to provide context to activate the LLM toward the most likely relevant learned relationships it embodies.

The output includes one or more datums responsive to the query of the prompt. For example, where the prompt seeks labels for one or more transaction and/or entity details, the output may include the requested information.

Referring to step 605, it may be determined that records of an LLM-labeled subset do, and that records of a second insufficiently labeled subset do not, meet LLM labeling criteria. The LLM-labeled subset and the second insufficiently labeled subset may each comprise records output from the LLM's labeling process. In one or more embodiments, the determination is made by a kickout filter comprising or that is executed by a program of a service device (e.g., filter 514 of FIG. 5 executed on service device 16 of FIG. 1 in a local environment), as discussed in more detail in preceding sections, and/or otherwise in accordance with the discussion above. Accordingly, it should be appreciated that related operations described above may also occur within the scope of the present invention.

Referring to step 606, requests may be submitted for training labels to human labelers for the second insufficiently labeled subset. In one or more embodiments, the human labelers correspond to labelers 516 (FIG. 5) which may perform labeling functions and operations via client devices 12 in a local environment and/or remotely, as discussed in more detail in preceding sections, and/or otherwise in accordance with the discussion above. Accordingly, it should be appreciated that related operations described above may also occur within the scope of the present invention.

The human labelers may produce sufficiently labeled human labeler output records. Each record may include or be associated with human input providing labels, portions or strings of the records corresponding to the labels, confidence indicator(s) for the labels, or the like.

Further, in one or more embodiments, it may be determined that records of a human labeled subset do, and that records of a third insufficiently labeled subset do not, meet human labeling criteria. The human labeled subset and the third insufficiently labeled subset may each comprise records output from the human labeling process.

In one or more embodiments, the determination is made by a kickout filter comprising or that is executed by a program of a service device, analogous to first and second kickout filters discussed in more detail in preceding sections, and/or otherwise in accordance with the discussion above. Accordingly, it should be appreciated that related operations relating to the first and second kickout filters or otherwise described above may also occur within the scope of the present invention.

Each record which meets the human labeled criteria of the filter may be flagged or otherwise considered sufficiently labeled and ready for use in training data for the OB machine learning models. For example, in one or more embodiments, each such record or group of such records may be stored in a memory space from which training data are retrieved or derived, flagged with a value indicating sufficient labeling, or otherwise segregated and/or indicated.

The method may include additional, less, or alternate steps and/or device(s), including those discussed elsewhere herein, unless otherwise expressly stated and/or readily apparent to those skilled in the art from the description.

For example, the keyword labeled subset, the LLM-labeled subset, and the human-labeled subset of the plurality of OB transaction records may be used to train an OB machine learning model tasked with analyzing OB data such as OB memo fields of corresponding financial transactions. For example, such an OB machine learning model may be configured to identify string(s) within such fields and map them to standardized entities within the scope of the present invention. One of ordinary skill will appreciate that the records of one or more of the keyword labeled subset, the LLM-labeled subset, and the human-labeled subset may be processed to prepare same for training the OB machine learning model (e.g., by decoding tokens comprising LLM output records into human readable format or otherwise preparing a training data set).

Accordingly, OB machine learning models trained with labeled data produced by a system of embodiments of the present invention may be more readily, quickly, and accurately produced, thereby enabling the OB service provider to adapt to changing conditions and/or expand into additional geographic markets with relative ease.

For another example, as discussed in more detail in preceding sections, the service device program may also be configured to automatically analyze sufficiently labeled LLM output records and revise or update the keyword based labeling process accordingly. The program may be configured to identify a pattern or correlation between a training label and one or more corresponding strings in a record of the LLM-labeled subset, determine that the pattern or correlation satisfies a confidence threshold, and, based on the determination that the pattern or correlation satisfies the confidence threshold, implement a new rule embodying the pattern or correlation for the keyword based labeling. String/label pairs which are more frequently output and/or have high and/or consistent confidence indicators, and/or the like, may lead the program to create new rules for such mapping relationships and/or to revise associated priorities and/or confidence indicators within the plurality of rules of the keyword based labeling process. In one or more embodiments, prompts to the LLM may request confidence indicator(s) for each label applied to the record(s), and such indicator(s) may be included in output and considered in the analysis described here for implementing new and/or revising existing rules of the plurality of rules.

The program may also be configured to automatically analyze sufficiently labeled human labeler output records and revise or update the keyword based labeling process accordingly. The program may be configured to identify a pattern or correlation between a training label and one or more corresponding strings in a record of the human labeled record subset, determine that the pattern or correlation satisfies a confidence threshold, and, based on the determination that the pattern or correlation satisfies the confidence threshold, implement a new rule embodying the pattern or correlation for the keyword based labeling. Again, string/label pairs which are more frequently output and/or have high and/or consistent confidence indicators, and/or the like, may lead the program to create new rules for such mapping relationships and/or to revise associated priorities and/or confidence indicators within the plurality of rules of the keyword based labeling process.

Further, the program may also be configured to automatically analyze sufficiently labeled human labeler output records, generate corresponding fine-tuning training data for the LLM, and fine-tune the LLM accordingly. The program may be configured to identify a pattern or correlation between a training label and one or more corresponding tokens in a record of the human-labeled subset, determine that the pattern or correlation satisfies a confidence threshold, and, based on the determination that the pattern or correlation satisfies the confidence threshold, generate a training data set for fine-tuning the LLM, with the training data set including labeled training data embodying the pattern or correlation. Where a plurality of different and frequently output labels are associated with a variety of similar input string(s), making distinction between them and proper label application more difficult, the program may be configured to automatically curate a labeled training data set with numerous examples embodying the various correct input string/label pairings and permutations thereof, and to fine-tune the LLM using the curated labeled training data set.

In one or more embodiments, curating the labeled training data set may include generating and/or retrieving a training record definition. The training record definition may be automatically generated by the program of the service device based on observed patterns and correlations between input to and output quality from one or more LLMs.

The training record definition includes a description of one or more types or categories of data such as open banking records and enables automated curation of the training data set. More particularly, the definition may describe one or more record types, such as open banking data, financial institution (FI) data regarding or including transaction records, account records, transaction and credit card data, firmographic entity data, location data, entity identification and/or authentication data, and/or other financial and related data. The definition may, for each identified data record type, specify whether the data should be labeled, unlabeled, or the like, in each case in conformity with the training to be undertaken (e.g., self-supervised, supervised and/or reinforcement learning), which may also be identified in the definition. The definition may include timestamp or record data ranges and/or limitations, other filters or limitations on records to be used for training, and other details for data preparation for and implementation of fine-tuning and implementation of the fine-tuned LLM.

For example, a definition may be selected and/or generated for its expected efficacy in improving entity identification for prompts including open banking memo fields exhibiting certain abbreviation patterns associated with entity identifiers. The definition may instruct: collection of a batch labeled open banking memo fields of corresponding financial transactions occurring with a threshold recency; filtering of the collected open banking memo fields according to the certain abbreviation patterns (i.e., to include only those fields within a certain distance of or with sufficient similarity to the certain abbreviation pattern(s)); construction of fine-tuning input from the collected and filtered labeled memo fields for consumption by the LLM (i.e., encoding the memo fields to encode/tokenize them for consumption by the LLM); and/or scheduling fine-tuning operations and coordinating replacement of the current production LLM with the retrained and fine-tuned LLM following training.

In one or more embodiments, the training data set is generated from a draft training data set by automatically analyzing the draft training data set for PII and redacting or anonymizing the PII, for example where the LLM is to be fine-tuned remotely and/or in a cloud computing environment.

It should be appreciated, as discussed in more detail below, that curation of the training data set is dependent on the particular OB labeling tasks for which the LLM is being trained to participate.

It is foreseen that machine learning methods may be used to support learning by the program and/or service device in connection with revising and/or updating the plurality of rules of the keyword based labeling process, updating filter criteria, and/or curating training data for and conducting fine tuning of the LLM. The machine learning program(s) supporting the labeling system may therefore recognize or determine correlations between training labels and input record(s)/string(s) and associated datapoints.

The machine learning techniques or programs may include curve fitting, regression model builders, convolutional or deep learning neural networks, combined deep learning, pattern recognition, or the like. Based upon this data analysis, the machine learning program(s) may learn method(s) for revising and/or updating the plurality of rules of the keyword based labeling process, updating filter criteria, and/or curating training data for and conducting fine tuning of the LLM, for use in improving embodiments of the present labeling system.

It should be noted that, in supervised machine learning, the labeling system may be provided with example inputs (i.e., input record strings) and their associated outputs (i.e., labels), and may seek to discover a general rule that maps inputs to outputs for improved revising and/or updating the plurality of rules of the keyword based labeling process, updating filter criteria, and/or curating training data for and conducting fine tuning of the LLM. In unsupervised machine learning, the labeling system may be required to find its own structure in unlabeled example inputs.

The labeling system may utilize classification algorithms such as Bayesian classifiers and decision trees, sets of pre-determined rules, and/or other algorithms.

Further, in one or more embodiments, the results of the keyword based labeling process and/or the LLM are analyzed by a rule explainability process. The rule explainability process may track the input and output from each of the keyword based labeling process and/or the LLM, extract relevant data therefrom, and produce human readable explanations of each determination and/or label application made by those processes. For example, the rule explainability process may generate a plain language text summary of labels and corresponding rules/prioritization/confidence indicators used to label a record by the keyword based labeling process. In turn, humans may review such explanations to better understand a result (e.g., satisfaction or non-satisfaction of labeling criteria), and to identify recommended changes for the system and/or otherwise debug the system (e.g., delete one or more rules from the keyword based labeling process where such rules, as explained, are non-sensical or do not appear based in dependable correlations).

Still further, it is foreseen that random samples of the output from each of the keyword based labeling process and LLM labeling process may be taken and forwarded to human labelers for quality checks and to ensure proper operation and/or evolution of the system of embodiments of the present invention.

It should be reiterated that a central goal of embodiments of the present invention is to provide a technological mechanism for evolved reduction in LLM and manual labeling burdens in connection with OB data annotation. Namely, embodiments of the present invention include an iterative three-stage labeling system for use with OB data annotation that incorporates interposed kick-out filters enabling such evolved burden reductions.

### Additional Considerations

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein, unless otherwise expressly stated and/or readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof) , registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S. C. § 112(f) unless traditional means-plus-function language is expressly recited, such as “means for”or “step for”language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

We claim:

1. Non-transitory computer-readable storage media having computer-executable instructions stored thereon for generative artificial intelligence (AI) assisted labeling of open banking (OB) data, wherein when executed by at least one processor the computer-executable instructions cause the at least one processor to:
perform keyword based labeling on a plurality of OB transaction records to generate a keyword labeled subset of the plurality of OB transaction records;
determine that each record of the keyword labeled subset meets keyword based labeling criteria;
determine that no record of a first insufficiently labeled subset of the OB transaction records meets the keyword based labeling criteria;
based on the determination that each record of the keyword labeled subset meets the keyword based labeling criteria, delay or omit submission of corresponding prompts to a large language model (LLM) for training labels for the keyword labeled subset;
based on the determination that no record of the first insufficiently labeled subset meets the keyword based labeling criteria, prompt the LLM for training labels for each record of the first insufficiently labeled subset to generate an LLM-labeled subset of the first insufficiently labeled subset;
determine that each record of the LLM-labeled subset meets LLM labeling criteria;
determine that no records of a second insufficiently labeled subset of the first insufficiently labeled subset meets the LLM labeling criteria;
based on the determination that the LLM-labeled subset meets the LLM labeling criteria, delay or omit submission of corresponding requests to one or more human labelers for training labels for the LLM-labeled subset; and
based on the determination that none of the records of the second insufficiently labeled subset meets the LLM labeling criteria, request training labels from the one or more human labelers for each of the records of the second insufficiently labeled subset to generate a human-labeled subset of the second insufficiently labeled subset.

2. The non-transitory computer-readable storage media of claim 1, wherein the computer-executable instructions further cause the at least one processor to—train an OB machine learning model with supervised learning based on the keyword labeled subset, the LLM-labeled subset, and the human-labeled subset of the plurality of OB transaction records.

3. The non-transitory computer-readable storage media of claim 2, wherein the computer-executable instructions further cause the at least one processor to—
determine that each record of the human-labeled subset meets human labeling criteria,
determine that no records of a third insufficiently labeled subset of the second insufficiently labeled subset meets the human labeling criteria,
the training based on the human-labeled subset being based on the determination that the human-labeled subset meets the human labeling criteria.

4. The non-transitory computer-readable storage media of claim 1, wherein the computer-executable instructions further cause the at least one processor to—
identify a pattern or correlation between a training label and one or more corresponding strings in a record of the LLM-labeled subset or the human-labeled subset,
determine that the pattern or correlation satisfies a confidence threshold,
based on the determination that the pattern or correlation satisfies the confidence threshold, implement a new rule embodying the pattern or correlation for the keyword based labeling.

5. The non-transitory computer-readable storage media of claim 1, wherein the computer-executable instructions further cause the at least one processor to—
identify a pattern or correlation between a training label and one or more corresponding tokens in a record of the human-labeled subset,
determine that the pattern or correlation satisfies a confidence threshold,
based on the determination that the pattern or correlation satisfies the confidence threshold, generating a training data set for fine-tuning the LLM, the training data set including labeled training data embodying the pattern or correlation.

6. The non-transitory computer-readable storage media of claim 1, wherein the delaying or omitting submission of prompts to the LLM and of requests to the one or more human labelers respectively includes one of saving to a memory space designated for training-ready records or applying a flag value indicating training-readiness.

7. The non-transitory computer-readable storage media of claim 1, wherein the keyword based labeling on the plurality of OB transaction records includes evaluating text tokens of the plurality of OB transaction records using a plurality of matching rules for training labels, each of the plurality of matching rules being associated with a confidence indicator.

8. The non-transitory computer-readable storage media of claim 7, wherein the keyword based labeling criteria are applied to each of the plurality of OB transaction records by calculating a record score for the record based on each training label applied to the record by the keyword based labeling and on the confidence indicator of the matching rule of the plurality of matching rules corresponding to the corresponding training label.

9. The non-transitory computer-readable storage media of claim 8, wherein the computer-executable instructions further cause the at least one processor to—
revise the confidence indicator of at least one of the plurality of rules based on one or
both of the LLM-labeled subset or the human-labeled subset.

10. The non-transitory computer-readable storage media of claim 1, wherein the LLM labeling criteria include—
a training label hallucination cross-check between (a) each record of the first insufficiently labeled subset, and (b) each record of the LLM-labeled subset and of the second insufficiently labeled subset,
a training label category check for each record of the LLM-labeled subset and of the second insufficiently labeled subset.

11. A computer-implemented method for generative artificial intelligence (AI) assisted labeling of open banking (OB) data, comprising, via one or more transceivers and/or processors:
performing keyword based labeling on a plurality of OB transaction records to generate a keyword labeled subset of the plurality of OB transaction records;
determining that each record of the keyword labeled subset meets keyword based labeling criteria;
determining that no record of a first insufficiently labeled subset of the OB transaction records meets the keyword based labeling criteria;
based on the determination that each record of the keyword labeled subset meets the keyword based labeling criteria, delaying or omitting submission of corresponding prompts to a large language model (LLM) for training labels for the keyword labeled subset;
based on the determination that no record of the first insufficiently labeled subset meets the keyword based labeling criteria, prompting the LLM for training labels for each record of the first insufficiently labeled subset to generate an LLM-labeled subset of the first insufficiently labeled subset;
determining that each record of the LLM-labeled subset meets LLM labeling criteria;
determining that no records of a second insufficiently labeled subset of the first insufficiently labeled subset meets the LLM labeling criteria;
based on the determination that the LLM-labeled subset meets the LLM labeling criteria, delaying or omitting submission of corresponding requests to one or more human labelers for training labels for the LLM-labeled subset; and
based on the determination that none of the records of the second insufficiently labeled subset meets the LLM labeling criteria, requesting training labels from the one or more human labelers for each of the records of the second insufficiently labeled subset to generate a human-labeled subset of the second insufficiently labeled subset.

12. The computer-implemented method of claim 11, further comprising, via the one or more transceivers and/or processors—
training an OB machine learning model with supervised learning based on the keyword labeled subset, the LLM-labeled subset, and the human-labeled subset of the plurality of OB transaction records.

13. The computer-implemented method of claim 12, further comprising, via the one or more transceivers and/or processors—
determining that each record of the human-labeled subset meets human labeling criteria,
determining that no records of a third insufficiently labeled subset of the second insufficiently labeled subset meets the human labeling criteria,
the training based on the human-labeled subset being based on the determination that the human-labeled subset meets the human labeling criteria.

14. The computer-implemented method of claim 11, further comprising, via the one or more transceivers and/or processors—
identifying a pattern or correlation between a training label and one or more corresponding strings in a record of the LLM-labeled subset or the human-labeled subset,
determining that the pattern or correlation satisfies a confidence threshold,
based on the determination that the pattern or correlation satisfies the confidence threshold, implementing a new rule embodying the pattern or correlation for the keyword based labeling.

15. The computer-implemented method of claim 11, further comprising, via the one or more transceivers and/or processors—
identifying a pattern or correlation between a training label and one or more corresponding tokens in a record of the human-labeled subset,
determining that the pattern or correlation satisfies a confidence threshold,
based on the determination that the pattern or correlation satisfies the confidence threshold, generating a training data set for fine-tuning the LLM, the training data set including labeled training data embodying the pattern or correlation.

16. The computer-implemented method of claim 11, wherein the delaying or omitting submission of prompts to the LLM and of requests to the one or more human labelers respectively includes one of saving to a memory space designated for training-ready records or applying a flag value indicating training-readiness.

17. The computer-implemented method of claim 11, wherein the keyword based labeling on the plurality of OB transaction records includes evaluating text tokens of the plurality of OB transaction records using a plurality of matching rules for training labels, each of the plurality of matching rules being associated with a confidence indicator.

18. The computer-implemented method of claim 17, wherein the keyword based labeling criteria are applied to each of the plurality of OB transaction records by calculating a record score for the record based on each training label applied to the record by the keyword based labeling and on the confidence indicator of the matching rule of the plurality of matching rules corresponding to the corresponding training label.

19. The computer-implemented method of claim 18, further comprising, via the one or more transceivers and/or processors—
revising the confidence indicator of at least one of the plurality of rules based on one or both of the LLM-labeled subset or the human-labeled subset.

20. The computer-implemented method of claim 11, wherein the LLM labeling criteria include—
a training label hallucination cross-check between (a) each record of the first insufficiently labeled subset, and (b) each record of the LLM-labeled subset and of the second insufficiently labeled subset,
a training label category check for each record of the LLM-labeled subset and of the second insufficiently labeled subset.
